(19) United States
(12) Patent Application Publication
(10) Pub. No.: US 2007/0136076 A1
(43) Pub. Date: Jun. 14, 2007

(54) Client property recordation service

(75) Inventors: Kenneth R. Goldberg, Coral Springs, FL (US); Bruce Roberson, Coral Springs, FL (US)

Correspondence Address: PATENTS ON DEMAND, P.A., 4581 WESTON ROAD, SUITE 345, WESTON, FL, 33331, US

(73) Assignee: Arkiva, Inc., Coral Springs, FL (US)

(21) Appl. No.: 11/287,986

(22) Filed: Nov. 28, 2005

(51) Int. Cl. G06Q 99/00

(52) U.S. Cl. 705/1

(57) ABSTRACT

A method for handling information associated with property information in conjunction with a recordation service. The method including a step of enrolling a client with a recordation service. During the enrolling step the client can identify a property. The property can have at least one building located upon it. An agent can be sent to the property. The agent can capture images of the building. The images can be digitally stored in a data store remotely located from the property. A communication can be received from an authorized entity to access the images. Responsive to the communication, the authorized entity can be provided with at least a selected one of the digitally stored images.

### BACKGROUND

1. Field of the Invention

The present invention relates to the field of record management and, more particularly, to a novel record service for client property.

2. Description of the Related Art

Most people retain their most significant assets in a single location, which is often their residence. Sometimes their most cherished asset is a residential building itself. Other times, people more highly prize items contained within the residence, such as family heirlooms, keepsakes, important records, photographs, collections, and the like. Despite the value that people place upon their residence and items contained therein, few people take adequate measures to protect and/or record their valuables.

For example, the majority of homeowners have home insurance with fire, flood, theft, and other policy riders. Further, many people carry homeowner insurance policies or renters' insurance policies to protect the items contained within their homes. These policies are not useful in protecting assets having great personal but minimal pecuniary value from loss, such as keepsakes. Additionally, insurance policies often require a homeowner to substantiate the value and provide proof of ownership and loss before providing adequate reimbursement. Without this proof, policy holders are at the mercy of insurance adjusters, who often provide conservative valuations of loss, upon which payments to the policy holders are based.

Accordingly, many policy holders find themselves suffering financial hardships in the aftermath of a disaster. Often this financial hardship is in addition to emotional hardships such as, loss of utilities, necessities, a possible loss of health, a possible loss of life within a family, and similar difficulties, which in combination make it virtually impossible or at least exceedingly difficult for a disaster victim to recover. This situation is intensified at times of widespread disasters, such as flood, and hurricane, where a significant population is simultaneously affected. A widespread disaster exhausts resources of insurance companies, state and local government, and organizations that are designed to assist disaster victims. Thus, victims of widespread disasters have an even harder time recovering than victims of a more localized disaster, such as a theft or a house fire.

Disaster victims having previously recorded residential information, who are able to present this information to insurers in an organized fashion, are more likely to receive proper compensation and expedited handling from insurance providers than similarly situated victims not having this residential information. Unfortunately, a majority of insurance policy holders fail to record information about insured property or assets contained therein in a comprehensive enough fashion to be of aid in the event of a disaster. Moreover, policy holders with the foresight to record documents pertaining to their assets to protect themselves in the event of a loss, often store these documents at a “safe” location within the residence. When damage to the residence is significant, these documents can be lost. Even when the documents are not lost, policy holders, who are not particularly skilled in asset recordation, often lack sufficient documents to be of use in the aftermath of a disaster.

### SUMMARY OF THE INVENTION

The present invention discloses a client property recordation service for obtaining a digital record of a client property and assets contained therein or associated therewith. The client's property can include a residence, an investment property, a business location, and the like. Once a client subscribes to and/or purchases the recordation service, one or more service agents associated with a recordation entity that provides the service can travel to the client's property. Digital photographs and/or video clips can be taken of the property. Electronic annotations of items corresponding to the photographs can also be obtained at this time. Significant assets, such as keepsakes or valuable assets can be individually photographed and/or otherwise digitally recorded. Additionally, important documents located at the property, such as tax records, account records, birth certificates, driver licenses, credit card information, receipts, vehicle titles, and paper keepsakes, can be digitally copied. In one embodiment, sensitive documents can be immediately encrypted with a client provided password, so that non-authorized individuals are unable to access content of sensitive records. The service agents can categorize the digital information and can store this information in a storage space remote from the property. A client can thereafter access the remotely located storage space at will, such as through a Web browser communicatively linked to the storage space.

The service provided above can be utilized for any of a variety of different purposes, each of which is contemplated herein. For example, the service can be used to immediately provide a traveler with information, such as passport, bank account, and credit card information, upon request. In such a manner, a business traveler can obtain a digital version of a business record stored at a property associated with the recordation service. A traveler having his/her wallet stolen can also use the service to quickly obtain necessary information to protect bank accounts and credit cars, to have a driver license reissued, and the like.

In another example, the recordation service can be used for disaster recovery efforts, such as a flood, hurricane, or fire. Research has proven that few individuals properly record their residential assets, which makes it difficult to recover from disasters. The remote storage of records is extremely important to disaster recover efforts as often property owners store all records relating to the property at the property itself, which can be destroyed or damaged during a disaster. Additionally, residents rarely know what assets are most important to record and are not aware of the proper methodology for recording these assets to facilitate disaster recovery efforts should there be a need. The recordation service, hiring agents skilled in property asset recordation, overcomes these common problems.

In one embodiment, the asset recordation service can be a sub service of a property protection service designed to aid consumers in interacting with insurance providers and government entities after a disaster to obtain benefits to which the consumers are entitled but have difficulty obtaining. The asset recordation service can be a service automatically provided in conjunction with an insurance policy. Moreover, the asset recordation service can be coupled with an asset valuation service, which can be performed impendent of a valuation of an insurance adjustor and can be used to ensure that proper valuation of assets occurs. The valuation can occur before and/or after a disaster. In one contemplated embodiment, a pre disaster valuation effort can be verified and approved by an insurer prior to a disaster so that no arguments relating to asset valuation exist between a client and an insurer should a disaster occur.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a flow diagram of a system for recording property assets in accordance with an embodiment of the illustrative arrangements contained herein.

FIG. 2 is a schematic diagram of a system used by a recordation service in accordance with an embodiment of the inventive arrangements contained herein.

FIG. 3 shows two Web based interfaces for accessing digitally stored records of the recordation service in accordance with an embodiment of the inventive arrangements disclosed herein.

FIG. 4 is a flow chart of a method for a recordation service in accordance with an embodiment of the inventive arrangements disclosed herein.

### DETAILED DESCRIPTION OF THE INVENTION

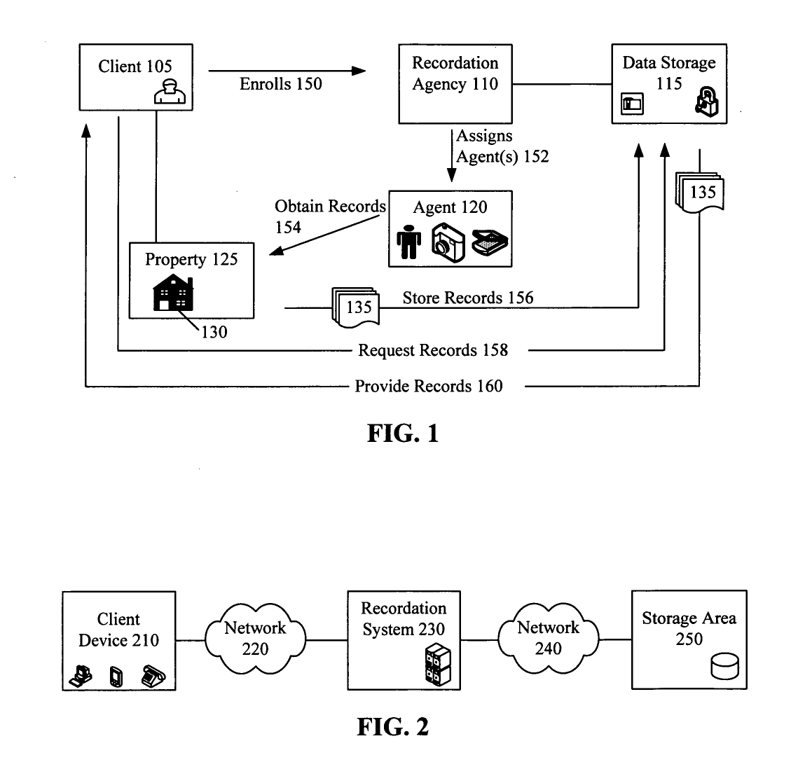

FIG. 1 is a flow diagram of a system 100 for recording property assets in accordance with an embodiment of the illustrative arrangements contained herein. In system 100, a client 105 can own/rent/lease a property 125 containing a building 130. Client 130 can enroll 150 in a recordation service provided by recordation agency 110. Recordation agency 110 can assign 152 one or more agents 120 to travel to the property 130.

Each agent 120 can bring digital recordation equipment, such as a digital camera, a document scanner, a portable computer, a video camera, and the like to the property 125. Using this equipment, the agent can obtain records 154 relating to the property 125. For example, the agent 120 can photograph the inside/outside of building 130, can scan paper documents contained within building 130, and can backup digital records stored within building 130. The agent 120 can also make digital annotations concerning assets at property 125, pictures taken of building 130, and of scanned documents.

The information recorded by agent 120 can be used to construct one or more electronic documents 135, which are stored 156 in data storage space 115. In one embodiment, the electronic documents 135 and information contained therein can be edited, supplemented, and otherwise modified by the client 105.

Any time after the electronic documents 135 have been placed in data storage space 115, client 105 can request 158 one or more of the electronic documents 135, which are provided 160 to the client 105 in response to the request.

The client 105 can be any person or entity having an associated property 125 that chooses to engage the services of recordation agency 110. For example, client 105 can be a homeowner or a home renter that contracts with recordation agency 110 to digitally record assets that client 105 keeps in his/her home as well as record conditions of the home itself In another example, client 105 can be a small to a medium sized corporation that utilizes the services of recordation agency 110 to digitally record and store business assets associated with business property 125.

Recordation agency 110 can be a business entity that provides a digital recordation service as described herein. The recordation agency 110 can provide the agent 120, the data storage space 115, one or more interfaces between the client 105 and the data storage space 115, equipment used by agent 120, and other hardware/software/firmware related to the digital recordation service. It should be appreciated that the recordation agency 110 need not own or exclusively hire the assets or personnel that it provides, but can instead subcontract with other entities to obtain needed resources.

In one embodiment, the recordation agency 110 can be a disaster recovery agency that provides the recordation service to mitigate problems that clients 105 suffer after a disaster, such as a flood or a hurricane. The recordation agency 110 can partner with other entities, such as insurance companies, government agencies, property valuation companies, builders, and the like to provide a full service disaster recovery solution.

For example, after a disaster, the recordation agency 110 can send one or more agents 120 to record the post disaster condition of property 125. This information can be compared with a pre disaster record previously stored in data storage space 115 and a damage assessment can be automatically performed. The recordation agency 110 or one of its affiliates can use these records to generate an insurance claim. One or more partnered builders can review the claim before its submission and can provide verified bids to ensure that damage to property 130 can be rectified for the amounts specified in the insurance claim. The insurer can then reimburse the client 105 for the specified amount and/or contract with the partnered builders to have the repairs performed.

Recordation agency 110 is not, however, to be construed as limited to an agency specializing in disaster recovery. Instead, the recordation agency 110 can perform the services detailed herein for any purposes. For example, the recordation agency 110 can be used by realtors to record a condition of a home to be listed and to provide digital records/photographs, which can be used for an electronic listing of property 125.

Agent 120 can be any individual or group of individuals that records information about the property 130. In one embodiment, agent 120 can include client 105, who can take digital pictures or perform document scans of his/her own property 130. Software and/or service technicians can be available for clients 105 who record their own property 125 records to guide the client 105 though the recordation process.

Data storage space 115 can be any storage location for digital information that is remotely located from property 125. The remote location of data storage 115 is important to prevent a disaster affecting property 125 from also affecting information stored in data storage space 115. Records contained within data storage space 115 can be encrypted to prevent unauthorized access. Additionally, one or more automated interfaces for accessing information contained within data storage space 115 can be provided. For example, a Web interface and/or an IVR interface can be provided through which client 105 can automatically obtain stored records without interfacing with a customer service representative. It is contemplated, however, that one or more customer service representatives can be used to interact with client 105 and to provide client requested records.

FIG. 2 is a schematic diagram of a system 200 used by a recordation service in accordance with an embodiment of the inventive arrangements contained herein. In one embodiment, components detailed in system 200 can be components of system 100. For example, storage area 250 can represent one manner for implementing data storage 115. Recordation system 230 can be a computing system used by recordation agency 110.

System 200 can include client device 210, recordation system 230, and storage area 250, which are communicatively linked through network 220 and network 240, respectively.

Client device 210 can be a computing device configured to interface with recordation system 230. The client device 210 can include device that communicates over a data network. The client device 210 can, therefore, include a computer, a tablet PC, a personal data assistant (PDA), a smart phone, and other such devices. The client device 210 can also include a telephony device, such as a telephone, fax machine, or mobile phone.

Recordation system 230 can include the hardware/software components for managing a recordation service. Recordation systems 230 can include management information system (MIS) for enrolling clients in the recordation services, for assigning agents to various properties, for coordinating for partnered companies, for billing and accounting matters, and the like. The recordation systems 230 can include software accessed by customer service operators that provides the operators with client specific details. Recordation systems 230 can also include one or more interactive voice response (IVR) system and/or one or more Web servers, which interactively provide automated account information and/or account services to client devices 210 in response to client requests.

Storage area 250 can be a physical or virtual storage space configured to store digital information. Storage area 250 can be physically implemented within any type of hardware including, but not limited to, a magnetic disk, an optical disk, a semiconductor memory, a digitally encoded plastic memory, a holographic memory, or any other recording medium. Storage area 250 can be a stand-alone storage unit as well as a storage unit formed from a plurality of physical devices. Additionally, information can be stored within storage area 250 in a variety of manners. For example, information can be stored within a database structure or can be stored within one or more files of a file storage system, where each file may or may not be indexed for information searching purposes. Further, storage area 250 can utilize one or more encryption mechanisms to protect stored information from unauthorized access.

Networks 220 and 240 can include any hardware/software/and firmware necessary to convey data encoded within carrier waves. Data can be contained within analog or digital signals and conveyed though data or voice channels. Networks 220 and 240 can include local components and data pathways necessary for communications to be exchanged among computing device components and between integrated device components and peripheral devices. Networks 220 and 240 can also include network equipment, such as routers, data lines, hubs, and intermediary servers which together form a data network, such as the Internet. Networks can also include circuit-based communication components and mobile communication components, such as telephony switches, modems, cellular communication towers, and the like. Each of the networks 220 and 240 can include line based and/or wireless communication pathways.

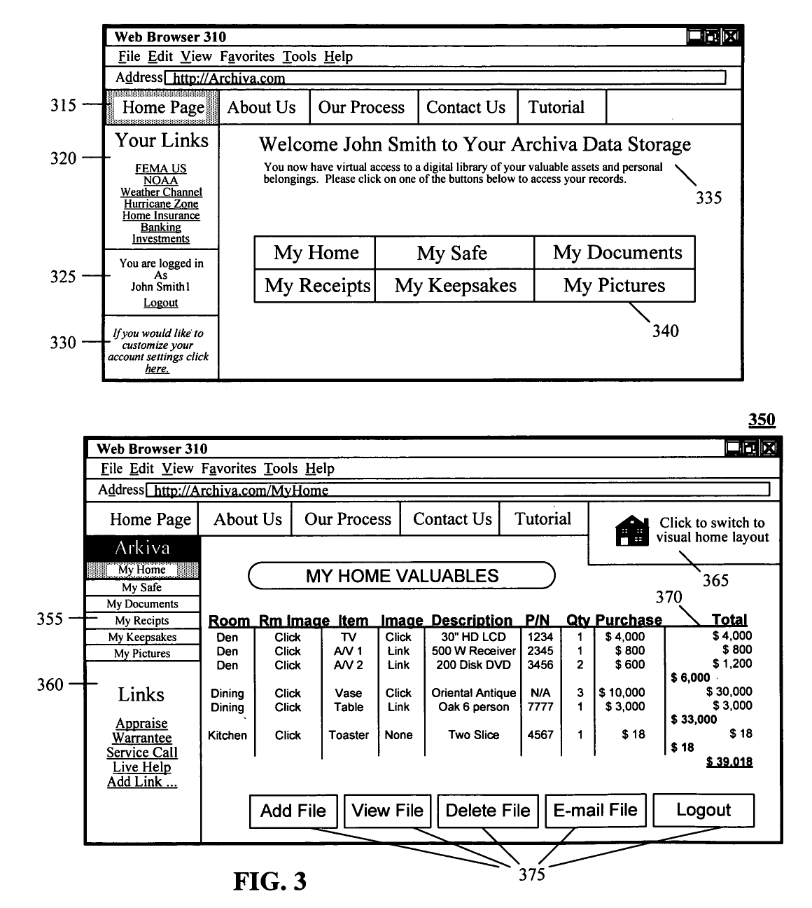

FIG. 3 shows two Web based interfaces, graphical user interface (GUI) 300 and GUI 350, for accessing digitally stored records of the recordation service in accordance with an embodiment of the inventive arrangements disclosed herein. GUI 300 and GUI 350 can be Web based interfaces accessible from within Web browser 310. In one embodiment, GUI 300 and GUI 350 can be interfaces used by client 105 and/or executing upon client device 210.

GUI 300 can be a home page for a Web site that provides an interface accessible by customers to records stored using a recordation service. GUI 300 can include a navigation section 315, a link section 320, a login section 325, a configuration section 330, a welcome section 335, and a view selection 340 section.

Navigation buttons 315 can be used to accessing different portions of the Web site. As illustrated, navigation buttons 315 can include buttons for a home page, an about page, a process description, a contact page, and a tutorial.

Links section 320 can contain links to relevant sites which may or may not be partnered with the recordation service. Links can be automatically selected based upon the purpose for which records are stored. If the primary purpose that records are accessed by GUI 300 is for disaster recovery, links can be provided to a weather site, an insurance site, a banking site, and the like.

Login section 325 can permit a user to provide a user name and password to login. Once logged in, an option can be provided to permit a user to logout. Section 330 can permit a user to customize the look and feel of GUI 300 and any other screen associated with the recordation Web site. Welcome section 335 can provide a brief welcome message, a service overview, and other such general information.

View section 340 can permit a user to view their stored documents in a number of different manners. Content provided within the different views of view section 340 can be redundant with other views. For example, similar content can appear in the “my home” view as in the “my safe view”, which is organized in a different manner. The views can permit a user to quickly locate desired information in an intuitive manner.

GUI 350 illustrates one contemplated arrangement for the “my home” view. GUI 350 can list a plurality of items in an item table 370 organized by the room of a house in which the items appear. The items can appear as rows in table 370. Table 370 can also include multiple columns, each containing an attribute for the item. Columns of table 370 can include, but are not limited to, a room column, a room image, an item column, an item image, a description column, a part number column, a quantity column, a purchase price column, and a total price column.

When an image cell is selected in table 370, an appropriate image for that cell can be presented. For example, when room image cell having a row heading of Den is selected, one or more pictures of the Den of a home can be presented. In another example, when an item image cell is selected, an image of that item, or an image of a room where the item is visible can be presented. One or more record buttons 375 can permit records to be added, viewed, deleted, emailed, and the like.

In one embodiment, an alternative home view can be provided, such as a visual home view 365. In the visual home view 365, a layout of a home can be presented and the user can zoom in on different rooms and/or items by selecting them within this layout. For example, the layout can permit a user to virtually walk through the various rooms in a house and to pick up and examine items in the rooms. Stored records can be retrieved for the items selected with the virtual rooms responsive to user selections.

GUI 350 can also include buttons 355 to other item views, such as the “my safe” view, the “my documents” view, the “my receipts” view, the “my keepsakes” view, and the “my pictures” view. A Web links section 360 customized for GUI 350 can also be presented. Links in section 360 can be dynamically adjusted for a home and/or for items currently presented in table 370.

It should be appreciated that GUI 300 and 350 are provided to demonstrate concepts described for an embodiment of the inventive arrangements disclosed herein. GUI 300 and GUI 350 are not intended to constrain the scope of the invention to a particular contemplated expression. Derivatives of GUI 300 and 350 including different interface elements, arrangements, layouts, and the like are contemplated herein. Further, the invention is not limited to using graphical interfaces. Voice interfaces, multimodal interfaces, telephony interfaces, three dimensional interfaces, and the like are also contemplated.

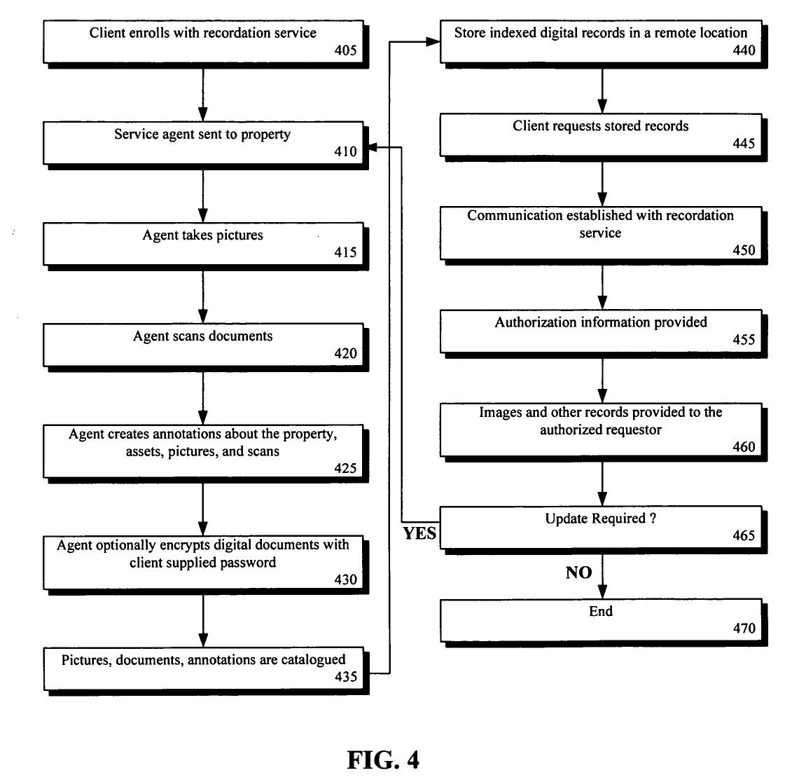

FIG. 4 is a flow chart of a method 400 for a recordation service in accordance with an embodiment of the inventive arrangements disclosed herein. Method 400 can be performed in the context of any property recordation system, such as system 100 or system 200.

Method 400 can begin in step 405, where a client can enroll with a recordation service. Different subscriptions or enrollment options can be provided at different fees. For example, an economy subscription can provide the client with a basic ability to store and retrieve records. A standard subscription can additionally entitle the client to have an agent make an initial recordation at the client's property. A premium subscription can entitle a subscriber to annual or semiannual record updates performed by agents as well as more detailed record annotations, document scanning, and other options.

Assuming at least a standard subscription, the method can progress to step 410, where a recordation service agent can be sent to a client designated property. The service agent can travel with any necessary technology the devices to make a digital archive of the home. For example, the agent can bring and utilize notebook computer, a digital camera, and scanner, a video recorder, and the like. In step 415, the agent can take pictures of the property and any structures contained upon the property. When the property includes a building, pictures of the inside of the building can be taken, such as on a room-by-room basis.

In optional step 420, documents stored at the residence can be scanned by the agent. In step 425, the agent can create annotations about the property, assets, pictures, and scans. In optional step 430, a client can provide a password unknown to the agent so that a digital record is only accessible by the client. For example, if the agent is scanning sensitive documents, the client can supply an encryption key unknown to the agent that is used to encrypt all scanned documents.

In step 435, pictures, documents, annotations, and the like can be catalogued. Additional annotations can be made to items obtained from the property at this time. For example, additional annotations concerning the present value of objects can be added by a valuation specialist. In step 440, the indexed digital records can be stored in a location remote from the property. The indexed digital records will commonly be recorded within a database structure in a network data storage. The networked data storage can be a redundant storage array and/or a clustered storage system for increased fault tolerance and to ensure data integrity is maintained.

In step 445, a client can request stored records. The request can be made through an automated system, to a live service agent, through postal mail channels, or though any other means. In step 450, a communication can be established between the client and the recordation service. Often authorization will be required during this communication to ensure that the client is authorized to access requested records. In step 455, the client can provide authorization information. It should be appreciated that multiple authorization levels may be include in method 400. For example, an initial client name/password may be needed to obtain general access to the records. Individual records can also be encrypted with different passwords, which must be provided before content contained within those records is provided. In step 460, images and other requested records can be provided to the authorized requestor.

Periodically, changes will occur in the property assets that will require records to be updated. For example, records can be automatically updated on a semi-annual basis by service agents for a charge. In step 465, if an update is required, the method can loop back to step 410. If no update is required, the method can proceed to step 470, where it can end.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for handling information associated with property information in conjunction with a recordation service, said method comprising:
enrolling a client with a recordation service, wherein during the enrolling step the client identifies a property, said property having at least one building;
sending an agent of an entity that provides the recordation service to the property;
said agent capturing a plurality of images of the building;
digitally storing the images in a data store remotely located from the property;
receiving a communication from an authorized entity to access said images, wherein said authorized entity is an entity different from the entity that provides the recordation service and wherein the authorized entity has been authorized by the client; and
responsive to the communication, providing the authorized entity with at least a selected one of the digitally stored images.

2. The method of claim 1, wherein the property is a residence of the client.

3. The method of claim 1, wherein the recordation service is a part of a disaster recovery service that assists the client in loss recovery efforts related to the property.

4. The method of claim 3, wherein the capturing step occurs before the property experiences a disaster, and wherein said images are provided to an insurer of the property.

5. The method of claim 3, further comprising:
performing the capturing and storing steps before a disaster as part of the recordation service; and
repeating the capturing and storing steps after said disaster as part of the recordation service.

6. The method of claim 1, wherein said recordation service includes at least one subscription option for which the client pays a periodic fee, said subscription option entitling the client to have images of the property automatically updated in accordance with details specified in the subscription option.

7. The method of claim 1, wherein the captured and stored images include images of the inside and outside of the building.

8. The method of claim 1, wherein the captured and stored images include images of the outside of the building that are of a sufficient quality and quantity that a three dimensional image of the exterior of the building is able to be constructed based upon the images, wherein said three dimensional image is able to be viewed from any cardinal compass point.

9. The method of claim 1, wherein the captured and stored images include images of the inside of the building, wherein said images include at least one image of each interior room of the building for which the client has permitted said agent to capture images, wherein said enrolling step entitles said client to have said agent capture images of every interior room of the building.

10. The method of claim 1, wherein each of the images includes at least one annotation associated with an item included within the image, wherein said at least one annotation is stored in an indexed fashion within the remote data store, wherein said indexing is performed by the entity that provides the recordation service, and wherein at least a portion of the annotations are created by an agent of the entity that provides the recordation service.

11. The method of claim 10, wherein a one to many correspondence exists between at least a portion of the images and the annotations, and wherein a one to many relationship exists between at least a portion of the annotations and the images.

12. The method of claim 10, wherein said communication identifies one of the annotated items, said identified item being associated with a plurality of images, wherein the plurality of images associated with the item are provided to the authorized agent responsive to the communication.

13. The method of claim 10, wherein at least a portion of said annotations include monetary valuations for the annotated item.

14. The method of claim 1, wherein the communication occurs between the authorized entity and an automated system associated with the recordation service, wherein the providing step is automatically performed by the automated system, said method further comprising:
authorizing the authorized entity to access the plurality of images associated with the property based upon a user identifier and password.

15. The method of claim 14, wherein said receiving, authorizing, and providing step occur via a Web portal accessed by the authorized entity via a Web browser.

16. The method of claim 15, wherein said Web portal is configured to permit interior images of said building to be categorized, searched, and presented by room.

17. The method of claim 1, further comprising:
said agent identifying a plurality of paper documents located at said property;
said agent converting each of said paper documents to a digital representation of the paper document; and
storing each digital representation within the data store in a manner accessible by the authorized entity.

18. A method for archiving residential information utilizing a recordation service, said method comprising:
enrolling a client with a recordation service, wherein during the enrolling step the client identifies a residence;
sending an agent of an entity that provides the recordation service to the residence;
said agent identifying a plurality of paper documents contained within the residence;
said agent converting each of said paper documents to a digital representation of the paper document;
storing each digital representation within the data store remotely located from the residence;
receiving a communication from an authorized entity to access said digital representations, wherein said authorized entity is an entity different from the entity that provides the recordation service and wherein the authorized entity has been authorized by the client; and
responsive to the communication, providing the authorized entity with at least a selected one of the stored digital representations.

19. The method of claim 18, further comprising:
said agent capturing a plurality of images of the residence; and
digitally storing the images in the data store in a manner accessible by the authorized entity.

20. A method for archiving records for disaster recovery purposes comprising:
providing a disaster recovery recordation service to a plurality of clients;
for each client, sending an agent to a client designated property to digitally record property assets;
storing records taken by the agent in a remote data store accessible by the client; and
conveying client requested ones of the stored records through an automated interactive interface.
